(19) United States
(12) Patent Application Publication
(10) Pub. No.: US 2024/0070774 A1
(43) Pub. Date: Feb. 29, 2024

(54) DECENTRALIZED RISK ASSESSMENT FRAMEWORK USING DISTRIBUTED LEDGER TECHNOLOGY

(71) Applicant: Ascenditur v3, LLC, Blairsville, GA (US)

(72) Inventors: Matthew Herrera, Blairsville, GA (US); Thomas Carson, Flowery Branch, GA (US); Alexander Matthey, Flowery Branch, GA (US)

(21) Appl. No.: 18/458,480

(22) Filed: Aug. 30, 2023

Related U.S. Application Data
(60) Provisional application No. 63/373,980, filed on Aug. 30, 2022.

(51) Int. Cl. G06Q 40/03

(52) U.S. Cl. CPC G06Q 40/03; G06Q 2220/10

(57) ABSTRACT

Systems and methods for implementing a blockchain-based risk assessment engine using any technique are described herein.

### CROSS-REFERENCE TO RELATED APPLICATIONS

This application claims priority to U.S. Provisional Patent Application No. 63/373,980 filed on Aug. 30, 2022, entitled “DECENTRALIZED RISK ASSESSMENT FRAMEWORK USING DISTRIBUTED LEDGER TECHNOLOGY”, the disclosure of which is hereby incorporated herein by reference in its entirety for all purposes.

### BACKGROUND

Traditional risk assessment frameworks typically involve the collection of personal data by a centralized agency (e.g., credit reporting agencies) that solicits, procures, stores, and analyzes an individual's personal data to make a risk assessment. This typically involves the calculation of a credit score that is used for a limited set of financial decisions, such as loan requests/leasing—covers personal loans, apartment leases, auto leases, and the like. In many cases, an individual is required to furnish sensitive data to the centralized agency and has no control over how the sensitive information is retained or used. An individual's lack of agency or control over his or her personal data may arise in undesirable consequences, such as the individual's data being used by the centralized agency in a way that is contrary to the user's wishes.

### TECHNICAL FIELD

Systems and methods described herein relate to techniques for decentralized risk assessment and data governance strategies that provide individuals with greater ownership and control over how sensitive and personal data is shared and used. In at least one embodiment, a blockchain network is utilized to implement a decentralized risk assessment framework.

### BRIEF DESCRIPTION OF THE DRAWINGS

FIG. 1 illustrates a computing environment 100 depicting a blockchain-based risk assessment engine, in accordance with one or more example embodiments of the present disclosure.

FIG. 2 illustrates a block diagram of an example machine 200 upon which any of one or more techniques (e.g., methods) may be performed, in accordance with one or more example embodiments of the present disclosure.

FIG. 3 shows an illustrative example of a process 300 for implementing a blockchain-based risk assessment system, in accordance with one or more example embodiments of the present disclosure.

FIG. 4 depicts an illustrative computing environment 400 in which discreet log protocol (DLC) functionality may be implemented to facilitate blockchain-based risk assessment, according to at least one embodiment of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

Techniques described herein may be utilized to implement decentralized risk assessment framework using distributed ledger technology. In various embodiments, a blockchain-based network such as a Bitcoin-based and/or Ethereum-based network may be utilized to implement a decentralized risk assessment framework. An individual or organization using a decentralized risk assessment framework as described herein may have greater control over how sensitive data is stored, shared, or otherwise utilized by other parties.

Traditional risk assessment frameworks typically involve the collection of personal data by a centralized agency (e.g., credit reporting agencies) that solicits, procures, stores, and analyzes an individual's personal data to make a risk assessment. This typically involves the calculation of a credit score that is used for a limited set of financial decisions, such as loan requests/leasing—covers personal loans, apartment leases, auto leases, and the like. In many cases, an individual is required to furnish sensitive data to the centralized agency and has no control over how the sensitive information is retained or used. An individual's lack of agency or control over his or her personal data may arise in undesirable consequences, such as the individual's data being used by the centralized agency in a way that is contrary to the user's wishes.

Furthermore, users may be distrustful of central identity management systems that have little or no oversight regarding how they store, utilize, and share their data. Identity management achieved in a centralized manner can have many implications, some of which may be desirable, others of which may be undesirable. In a centralized identity management environment, every user typically has to communicate with the same central identity management authority. For example, each user that wishes to access some resource on a computing network must first prove his or her identity to a server controlled by a central authority. The central authority then either notifies the computing network that a given user is authenticated or provides the given user with an authentication token that the given user must provide to the computing network. Thus, it is the central authority—not the user, that controls the user's identity. This may result in undesirable consequences. A user may be forced to use the central agency to prove his or her identity, provide credentials or certifications, proof of income, creditworthiness, and more. In either case, every user must contact the central authority to obtain access to resources of any computing network. However, such centralized identity management presents many challenges.

For instance, consider existing risk assessment models that are utilized by credit scoring agencies. These risk systems aid centralized agencies in their decision-making process in a backwards looking manner. While knowledge of historical information regarding an individual's past payment capacity may be useful in risk assessment, it is not necessarily an indicator of future performance. Furthermore, backwards looking risk assessment systems do not always consider all of the metrics relevant to providing a full picture for assessing an individual's risk. Therefore, there is a present desire and need for improving upon existing risk assessment frameworks that and improve upon the gut decision-making or historical assessments that are all too often relied upon to arrive at a final decision.

Existing risk assessment systems—such as those used by Equifax, Experian, and TransUnion —typically credit information of consumers and rate the overall ability to pay back a debt. Credit bureaus like Experian and Equifax provide the information they gather to creditors for a fee. Lenders, in turn, use the information in the reports to measure a prospective credit applicant's creditworthiness. However, these risk assessment systems typically fall short in that they use a limited set of historical information in determining a risk assessment score. For example, in the determination of a consumer's credit score, historical risk assessment systems typically use backwards looking information related to the finances of a consumer, such as account summaries of loans reported by creditors, public records relating to whether the consumer has bankruptcies, judgments, or liens against the consumer and/or the consumer's property, as well as involuntary arrangements. Previous credit checks and credit inquiries from creditors including a list of all of the credit applications that have been made by the borrower may also be considered. These credit agencies typically provide the same or similar services provided: credit score based on historical repayment history. Each provides a similar score based on historical repayment history and each provides a similar score, based on largely the same information, but actual scores vary slightly due to the data collected or the different weighting to their scoring methodologies or even the scoring ranges that consumers are plotted against. While providing largely the same information, these credit agencies nominally “differentiate” each other through the aforementioned techniques and possibly others. Traditional risk assessment systems have been used for loan requests, real property leases, personal loans, automobile loans and leases, etc. but only tells of past credit experience and lacks any insight into future capacity, which is arguably more important for a loan which is to be repaid over a period of time into the future.

Techniques described herein may be utilized to implement decentralized risk assessment framework using distributed ledger technology. In various embodiments, a blockchain-based network such as a Bitcoin-based and/or Ethereum-based network may be utilized to implement a decentralized risk assessment framework. An individual or organization using a decentralized risk assessment framework as described herein may have greater control over how sensitive data is stored, shared, or otherwise utilized by other parties.

In various embodiments, a risk assessment system is described herein that provides for improved credit worthiness assessments that is designed to tell the user more than just what they have been able to pay in the past but furthermore is used to outline why they have been able to achieve the scores produced by the historical risk assessment systems. In various embodiments, a risk assessment system described herein is able to produce an assessment of why a user has a certain historical risk assessment score (e.g., credit score provided by Equifax, Experian, TransUnion, or other credit scoring agencies), where the ongoing monitoring and updates provided, provides for ongoing assessments into a user's financial capacity and outlook, and more. In various embodiments, a risk assessment system described herein is implemented to consolidate and coordinate users' information and provide a platform that allows them to organize their personal finances and eliminates the guesswork out and gives the decision maker all of the info needed in one score and in place.

Consider, in contrast, existing credit reporting processes used by traditional credit scoring agencies. Current credit worthiness relies on a limited universe of information revolving around a backwards facing view on a user's financial health. This information includes: (i) a user's biographical information, such as the user's name(s), current and/or past addresses, phone number, social security number, date of birth, employment history, and more; (ii) scoring by credit agencies based on such historical information and/or as described above; (iii) derogatory financial events, such as financial obligations past due, debt collection, judgements, foreclosures, bankruptcies, etc.; (iv) credit information such as number of open and/or closed lines of credit, prior payment history, outstanding balances, and credit utilization; (v) verification points provided in credit inquires such as social security number match and reference with a master death list, list of previous entities who have requested credit reports, previously used names, addresses, phone numbers, social security numbers, and date of birth; and so on and so forth.

As described herein, blockchain networks may be utilized to store and control access to a user's own financial data. Data may be provided based on inputs collected over time, and the user can choose what information and how the information is shared with other entities. Techniques described herein may also provide a clear means to improve user scores. As of today, users must play a wait-and-see game as to how certain events might or might not improve their credit scores. Existing reports furthermore lack forward-looking elements and instead focus on historical capacity for scoring. In contrast, a risk assessment system implemented using techniques here utilizes additional information that provides forward-looking elements that provide a more accurate picture of a user's potential earnings and repayment abilities. Finally, having a user own his or her own identity can provide for greater fraud protection, as the owner of the information is the user himself, and providing an attestation of the information may be equivalent to providing an authentication of the user's identity as the two are directly linked to each other. Blockchain-based systems may be used to achieve these kinds of identity capabilities.

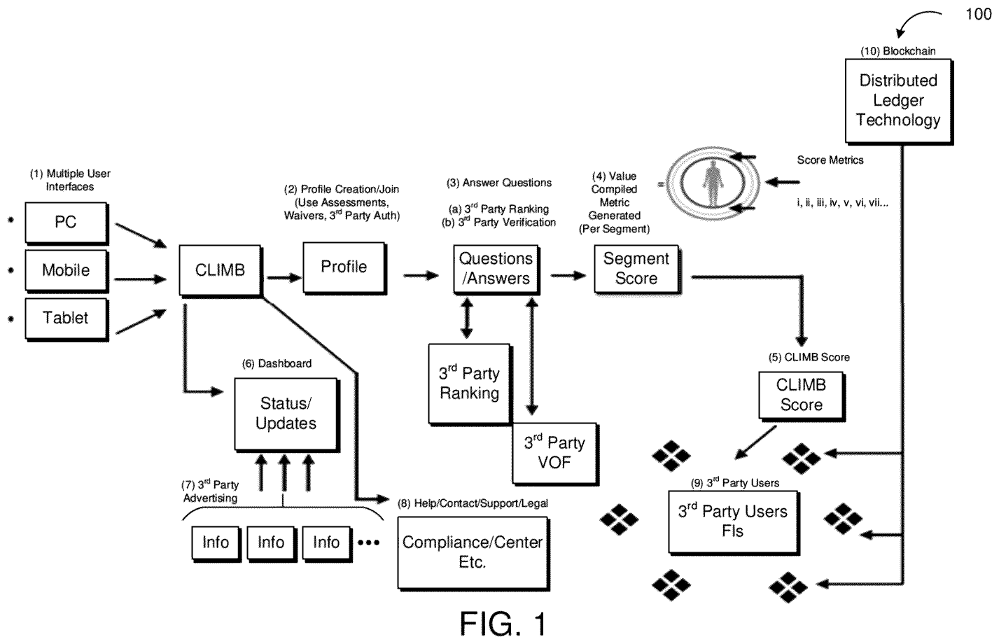

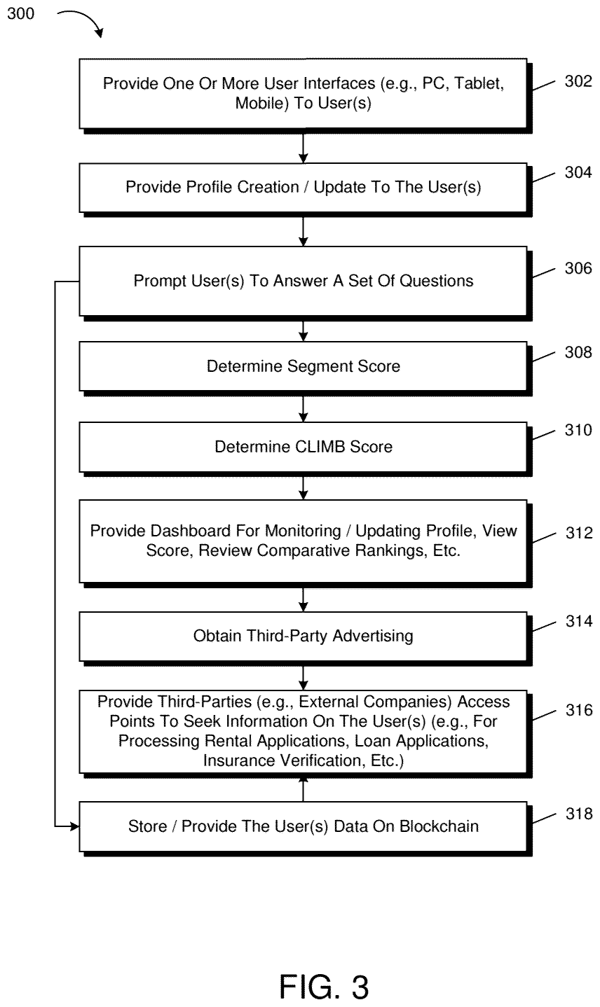

FIG. 1 depicts an illustrative computing environment 100 in which a decentralized risk assessment framework using distributed ledger technology may be implemented. It should be appreciated that FIG. 1 depicts an illustrative, non-limiting example implementation, and that other implementations are also contemplated within the scope of this disclosure, whose specific implementations may differ in various respects, which are described in detail below. Various aspects of FIG. 1 may be discussed in connection with FIG. 3, which is described in greater detail below.

In various embodiments, a blockchain-based risk assessment system described herein is designed to enhance current model and created with a new framework of information focused on ownership, enhanced knowledge, protection, repayment capacity, and support/coaching. In at least one embodiment, the blockchain network used to implement the risk assessment system is a Bitcoin-based and/or Ethereum-based blockchain network, but this should be considered a non-limiting example, and other types of blockchain networks, including but not limited to Bitcoin-based blockchain networks, may be utilized to implement other implementations and are contemplated within the scope of this disclosure.

A characteristic of the blockchain-based risk assessment system is that users will have ownership of their own data, as opposed to a central authority. Each user will own their own information and can freely update their profiles at any time on the blockchain. Furthermore, users can choose the information that they share with lenders. Each user's verified information can be used against credit reports to ensure accuracy. Discrepancies can be flagged and provide users of the blockchain-based risk assessment system of an understanding of the information being shared by the blockchain-based risk assessment system as compared to data on credit reports generated by central credit authorities such as Equifax, Experian, and TransUnion. In a blockchain-based risk assessment system, it is the user, not a central agency, that controls access to the user's information. By using smart contracts, decentralized applications, or other forms of decentralized computing, an approval system can put the user in control of how their creditworthiness is expressed and shared. A smart contract can be implemented in any suitable manner—for example, embodiments described herein may implement a smart contract on an Ethereum-based network using Solidity, implement a smart contract on a Bitcoin-based network using Clarity, and so on and so forth.

A blockchain-based risk assessment system provides the opportunity to leverage enhanced knowledge, according to various embodiments of the present disclosure. In various embodiments, a blockchain-based risk assessment system is used to store profile information for a user regarding his or her education, training, work experience, community out-reach, travel experiences, hobbies, and languages spoken. The enhanced data provides enterprise users meaningful understanding of each user and sets users apart from current market offerings.

In various embodiments, blockchain-based risk assessment systems described herein provide for superior data protection. A blockchain-based risk assessment system's usage of regulatory compliance regimes such as GDPR, CCPA, etc. ensures ongoing safety of the information being stored. Blockchain and, in some cases biometrics, may be used to provide for greater safety and/or data protection. The adoption of stricter safety measures is seen as an important feature to users, as they will be more likely to store their financial data when they are assured that such data is stored safely along with other insurance, legal, and medical information.

In various embodiments, a blockchain-based risk assessment system is used to determine repayment capacity. For example, a user may disclose wages and/or earnings information that is verifiable. An illustrative, non-limiting verification process may involve using tax return records which will be verified via a verification process using tax return records (e.g. IRS Form 4506-T). The introduction of repayment capacity allows users the unique ability to know how current obligations are being met and if the user can take on additional debt. The forward-looking element is a differentiating factor that is not found in other risk assessment systems. The blockchain-based risk assessment model will also provide an intermediary step for those with little to no payment histories by providing the ability to meet non-credit driven payments including but not limited to: rent, utilities, insurance premiums, etc.

In various embodiments, the blockchain-based mode is designed to aid in the development of users. Each user is assigned a score and can be ranked with all other users or a subset of other users with similar profiles. The education that comes with the comparison rankings will allow users to see how they are progressing and rank. The process will also allow users to chart their own advances allowing for ongoing personal improvement. This allows users to view themselves as being part of an online ecosystem where users come together for healthy collaboration and mutual advancement.

In various embodiments, aspects of repayment may involve the system requiring users to provide all three credit reports at first and with a long term goal to create a standalone system to measure and track credit payment history, inquiries, and other tracking (e.g., collections, judgments, past due payments, etc.) User metric will have the same use cases as noted above.

With regards to work experience, blockchain-based risk assessment systems described herein may monitor and track work experience and use analytics to provide insights when users have job updates, such as a promotion or change in role. Growth in field of work is measurable factor that goes into the scoring metric.

With regard to early education, a risk assessment score recognizes that everyone starts life at diverse levels with different advantages and disadvantages. Systems described herein may be designed to capture the base foundation each user starts from, charts growth, and uses analytics to provide insights on user performance relative to this metric.

With regard to civic engagement, metric may be used to capture to what extent user gives back and participates in community. Separate metrics designed to capture the monies invested into the community quantify their level of involvement.

Additional metrics may be used to gauge personal involvement in their communities and their world. Where the items being tracked can provide the following insight: travel and cultural experiences (perspective and understanding that provides experiences to mold and widen scope); organized activities and hobbies (tracking whether users keeping skills and passions inside or are helping others); post-secondary & professional education (tracking what users are doing to further themselves and if they are continuing to invest in their futures; languages; and more.

Scoring, unlike traditional credit reporting agencies, a single score encompasses all of the above, but will include a future cash flow component, complete with Debt Service Coverage (DSCR) and Debt to Income (DTI) metrics, along with liquidity and leverage metrics. One unified metric with past and future performance capacity. Sets individual up like an entity, where each have a detailed knowledge of repayment capacity and or early warning indicators for cash flow and or book leverage issues.

In various embodiments, the following value systems are metrics that will be extracted from the model. Various combinations of elements may be used:
i. SSD
ii. Traj
iii. Di
iv. Gi
v. Vci
vi. Pa
vii. Bip

In various embodiments the data lives on a blockchain network on chain and is accessible via a user's wallet. The data may be freely accessed by the user via any suitable manner, such as a mobile application. The user may be responsible for retaining control of a cryptographic key associated with the wallet.

Customer interactions may include viewable, informative, educational formats.

Outside party with customer information: Contingent on how they price risk, viewable—accessed from parent dashboard via a decentralized oracle network, such as the ChainLink network as described by “ChainLink: A Decentralized Oracle Network” (Ellis, Steve; Juels, Ari; and Nazarov, Sergey; Published 4 Sep. 2017), which is hereby incorporated by reference.

In various embodiments, significant amounts of data are produced from both the input and output resources from the risk model engine, and accessing only portions of the data set that are relevant to both the user and the outside party are provided for data metrics and dashboard. Once more of the computing power, latency of transactions on the blockchain are more fully developed then larger data sets may be utilized to produce more of a complete set of data as the ecosystem matures. The oracle is important development as it allows external data to the protocols, answering questions from smart contract deployment.

Steps for a request-response oracle may be summarized as follows: receive a query from a decentralized application; parse the query; check that the payment and data access permission are provided; retrieve relevant data from an off-chain source (and encrypt if necessary); sign the transaction(s) with the data included; broadcast the transaction(s) to the network; schedule any further necessary transactions, such as notifications, etc.; and so on and so forth.

In various embodiments, digital tokens such as NFTs will be the medium of exchange contingent on development in various ecosystems, with transaction type (buy, sell, lease, swap) best suited for various ecosystems. Data on the transaction/chain: public key, identifier of the wallet Smart contract: Hash of the certificate or utilized dashboard value metrics.

Uses: notate and record the uses of the metrics between the user and outside party.

Smart contract, programmable code stored on the blockchain. Code (e.g., functions) and data (state)) housed at an address, specific=contract address. The user interacts with the contract by calling functions via transactions, the destination address of transaction is the contract itself and the payload is the function to call.

This interaction is executed by the end user through a web application, wallet. This web application can be accessed on desktop, mobile, phone, tablet, or other electronically computational capable devices including but not limited to wearable devices, kiosks, hybrid screens, infotainment systems, handhelds, watches, interactive goggles or glasses, optical contact lens, helmets, headsets, and voice enabled devices.

The expression of value output into the smart contract may be performed using layer 2 or layer 3 technologies. The data may include:
Name
Description
Image URL
On-chain information
Certificate Name
Certificate Class
Certificate Owner
Certificate Approved
Certificate Minted

A “Layer 2” blockchain network may be characterized as a scaling solution that sits on top of a “Layer 1” blockchain network like Bitcoin or Ethereum. Layer 2's (or L2s) may be characterized in that they increase the speed and reduce the cost of transacting on a blockchain. Layer 2 networks may be similar to sidechains in some ways and may be different in others. For example, a L2 network generally relies on the security of the main chain, whereas sidechains have their own security properties.

A Layer 2 solution may be used to address the scalability challenges of L1 networks, including but not limited to high gas fees and network congestion. Layer 2 scaling solutions can take different forms, including payment channels, state channels, side chains and rollups.

A Layer 3 solution may refer to the layer where the user eventually interacts with the user interfaces (UI). When working with L1 and L2, this layer aims to give simplicity and ease. L3 may be used to provide UI functionality as well as intra-chain and/or inter-chain operability, such as access to decentralized exchanges, liquidity provisioning, and staking applications. Examples of L3 interfaces include decentralized crypto exchanges like Uniswap, wallet providers, liquidity management protocols, payments mechanisms, and more.

Off-chain information is to encompass include traits pertinent as identifiers of value to the individual being assessed during the transaction, URL for image/dashboard as a snapshot of the individual being assessed during the transaction, and so forth. Ecosystem token interoperability can either be direct on-chain or off-chain. Data source verification on-chain or cross-functional, on chain or off chain data exchange for addition or subtraction value input and output expression. Including static and dynamic tokens with top to bottom or bottom to top ownership contingent on preference and/or blockchain ecosystem capability with functional properties within operating protocol limitations.

In various embodiments, during the exchange of value from the enterprise to risk rate individual, the token [transaction] pull to have a set [firm, fixed] a pre-determined timeframe defined within smart contract [ns, ms, s] access of value exchanged [stamped] data as it pertains to risk analysis and risk scoring outputs between the token issuer and the engaged enterprise and individual. After the pre-determined timeframe has elapsed within the contract, the transaction concludes, the token is returned back to the scoring issuer, while maintaining key identifiers to source back to the individual for future use for future value callback/scoring. This provides the ability to re-score and return new value at a later date when the individual is scored for another assignment of risk, credit, debit, risk premium, or rewards] store credits, miles, points, or other means of value reward accrual, assignment]. Assignment of risk into monetary value—which could be monetarily converted, granted, or assigned either directly or indirectly on the chain/off the chain. Smart contracts to originate on blockchain networks have applicability to those blockchain protocols that enabled smart contracts capable with properties to conduct financial transactions with functionality on blockchains. The token [protocol] provides a more secure way to store risk analysis per individual providing stronger approach to individual sovereignty/self-custody, ownership of data, and data portability.

In at least one embodiment of the present disclosure, smart contracts implemented in Clarity may have the following baseline construct foundation:

```
(define-trait nft-trait
  (
  ;; Last token ID, limited to uint range
  (get last-token-id ( ) (response uint unit)
  ;; URI for metadata associated with the token
  (get-toke-uri (uint) (response ( optional (string-ascii 256 uint))
  ;; Owner of a given token identifier
  (get-owner (uint) response (optional principal) unit))
  ;; Transfer from the sender to a new principal
  (transfer (uint principal) (response bool uint)))
  )
)
```

A Clarity token assignment/transfer of value may be implemented in accordance with the following:

```
;; use the SIP-0009 interface
(impl-trait <trait identifier>.nft-trait.nft-trait)
;; define a new NFT.
(define-non-fungible-token <asset name> uint)
;; store the last issued token ID
(define-data-var last-id uint u0)
;; Claim a new NFT
(define-public (claim)
  (mint tx-sender))
;; SIP-0009: transfer token to a specific principal
(define-public (transfer (token-id uint) (sender principal) (recipient
principal))
  (begin
    (asserts! (is-eq tx-sender sender) (err u403))
    ;; (nft-transfer? <asset name> token-id sender recipient)))
(define-public (transfer-memo (token-id uint) (sender principal (recipient
principal) (memo (buff 34)))
  (begin
    (try! (transfer token-id sender recipient))
    (print memo)
    (ok true)))
;; SIP-0009: Get the owner of the specified token ID
(define-read-only ( )get-owner (token-id uint))
  (ok (nft-get-owner? <asset name> token-id)))
;; SIP-0009: Get the last token ID
(define-read-only (get-last-token-id)
  (ok (var-get last-id)))
;; SIP-0009: Get the token URI You can set it to any other URI
(define-read-only (get-token-uri (token-id uint))
  (ok (some “https://token.stacks.co/{id}.json”)))
;; Internal - mint new NFT
(define-private (mint (new-owner principal))
  (let ((next-id (+ u1 (var-get last-id))))
    (var-set last-id next-id)
    (nft-mint? <asset name> next-id new-owner)))
```

In at least some embodiment, a “blockchain” or “blockchain network” refers to any and all suitable forms of distributed ledgers, which includes consensus-based blockchain and transaction-chain technologies, permissioned and un-permissioned ledgers, shared ledgers, and more. Non-limiting examples of blockchain technology include Bitcoin and Ethereum, although other examples of blockchain technologies are also contemplated in the scope of this disclosure. While Bitcoin and Ethereum may be described in connection with various embodiments of this disclosure, those embodiments are to be construed merely as illustrative examples and not limiting. For example, alternative blockchain implementations and protocols are contemplated within the scope of the present disclosure.

A blockchain network may refer to a peer-to-peer electronic ledger implemented as a decentralized system. A ledger may comprise multiple blocks wherein a genesis block is a first block of the ledger and all other blocks reference a previous block. In at least some embodiment, each block (except the genesis block) includes a hash of the previous block to which that block became chained together to create an immutable record of the block to the blockchain ledger which cannot be modified, deleted, or otherwise altered. A block may include one or more blockchain transactions. A blockchain transaction may refer to a data structure that encodes the transfer of control of a digital asset between users of the blockchain network. For example, a blockchain transaction may transfer control of a digital asset from a source address to a destination address. The blockchain transaction may be signed with a private key associated with the address which can be cryptographically verified using a corresponding public key that is made available to other parties of the blockchain network. In at least one embodiment a blockchain transaction includes a transaction input and a transaction output.

In some embodiment, a blockchain transaction is validated before it is committed to the blockchain ledger as part of a block. Blockchain nodes may be used to verify blockchain transactions, which may include verifying digital signatures of transactions, verifying that a purported owner of a digital asset is actually the owner by inspecting the blockchain ledger to verify that control of the digital asset was transferred to the purported owner and that the purported owner has not elsewhere transferred control of the digital asset (meaning that the purported owner was previous the owner of the digital asset but has previously transferred control to another entity).

Validity in the blockchain context may be consensus based, and a transaction may be considered valid if a majority of nodes agrees that the blockchain transaction is valid. In at least some embodiments, a blockchain transaction references an unspent transaction output (UTXO) that is used to validate the transaction by executing the UTXO locking and unlocking script. If the UTXO locking and unlocking script executes successfully (e.g., by evaluating to TRUE and any other validation operations). Accordingly, a blockchain transaction is written to a blockchain ledger when it is validated by a node that receives the transaction and is added to a new block by a node (e.g., miner) and actually mined by being added to the public ledger of past transactions. In at least some embodiment, a blockchain transaction is considered to be confirmed when a certain number of subsequent blocks are added to the blockchain ledger, whereinafter the blockchain transaction becomes virtually irreversible.

A blockchain transaction output may include a locking script that “locks” a digital asset by specifying a condition that is to be met in order for the encumbrance to be lifted or unlocked (e.g., to allow control of the digital asset to be transferred to another user). A locking script may be referred to as an encumbrance. An unlocking script may be a corresponding script that in combination with the locking script, removes an encumbrance on digital assets. A locking script and unlocking script may be combined to form executable code that, if executed to completion or to yield a specific result, indicates that the unlocking script is valid and that the encumberance may be removed. For example, “scriptPubKey” is a locking script in Bitcoin and “scriptSig” is an unlocking script.

It should be noted that while blockchain technology is perhaps most widely known for its use cryptocurrency, there are many other applications for blockchain technologies for providing secure systems. A secure system may refer to a system in which functionality —such as the exchange of digital assets between two or more entities —is cryptographically verifiable. A secure system may be robust to failure. A secure system may be immutable such that information that is committed to the blockchain ledger cannot be unilaterally modified by an individual. A secure system may provide additional assurances, such as assurances of confidentiality, integrity, authenticity, and nonrepudiation. Confidentiality may refer to assurances that certain information is not made publicly available (e.g., the underlying identity of a blockchain address may be kept secret or unknown). Authenticity may refer to assurances that a message was created by a party purporting to be the author of the message. Integrity may refer to assurances that a received message was not modified either intentionally (e.g., by a malicious party) or unintentionally (e.g., as a result of signal loss during transmission) from its original form when the message was transmitted. Nonrepudiation may refer to assurances that a party that digitally signs a blockchain transaction cannot deny the authenticity of the transaction.

Mining may refer to the process of validating blockchain transactions along a blockchain network. Validating blockchain transactions may involve a process of securing and verifying blockchain transactions (e.g., organized as blocks) along a blockchain. Mining may be a process that helps maintain network security by ensuring that valid blocks are recorded on a blockchain ledger. Generally speaking, participants in a mining process can be rewarded for using computing resources (e.g., compute resources such as CPUs) to solve computational algorithms. Mining can be done in various ways. Proof-of-work (POW) and proof-of-stake (POS) consensus are two non-limiting examples of how mining can be done.

Proof-of-stake may refer to a consensus algorithm in which validators secure new blocks before they are added to a blockchain network. In a POS mining algorithm, a node may participate in the mining process by staking an amount of digital assets. The POS may be a deterministic concept that states individuals are allowed to mine or validate new blocks equal to proportionally to the amount staked—in other words, the more digital assets a node stakes, the greater mining power the node has. In some cases, greater mining power means that a node has more opportunity to validate blocks and be rewarded. Opportunity may refer to probabilistic opportunity, in which a probability p₁>p₂ does not necessarily guarantee that a first node with higher probability p₁ actually mines more than a second node with lower probability p₂ over a specific period of time. However, long-run, expected value of miners with larger staked amounts may be greater than those of miners with smaller staked amounts.

A node may become a miner by staking an amount of digital assets from the miner's blockchain wallet by transferring digital assets to a bound wallet. Miners, who may be called validators, delegates, or forgers, may be chosen or voted for randomly by holders of digital assets on the blockchain network. For a node to be chosen as a staker, the node needs to have deposited a certain amount or value of digital assets into a special staking wallet. In at least some embodiments, miners are entitled to forge or create new blocks proportional to the amount staked. In some embodiments, mining is managed by a service provider, which provides the computing resources that are needed to record new data to a ledger.

POS blockchain networks may have several important differences from POW blockchain networks. In general, anyone with enough digital assets can validate transactions on a blockchain network, and the benefits of specialized hardware such as application-specific integrated circuits (ASICs) is less pronounced than in POW blockchain networks. Generally speaking, POS blockchain networks may be more energy efficient and environmentally friendly than POW blockchain networks. Non-limiting examples of POS blockchain networks include: DASH; NEO; Lisk; Stratis; PIVX; OkCash; and more. Generally speaking, in a POW blockchain network, nodes with greater computing power are more likely to mine new blocks, whereas in POS blockchain networks, nodes with greater staking amounts are more likely to validators.

The above descriptions are for purposes of illustration and are not meant to be limiting. Numerous other examples, configurations, processes, etc., may exist, some of which are described in greater detail below. Example embodiments will now be described with reference to the accompanying figures.

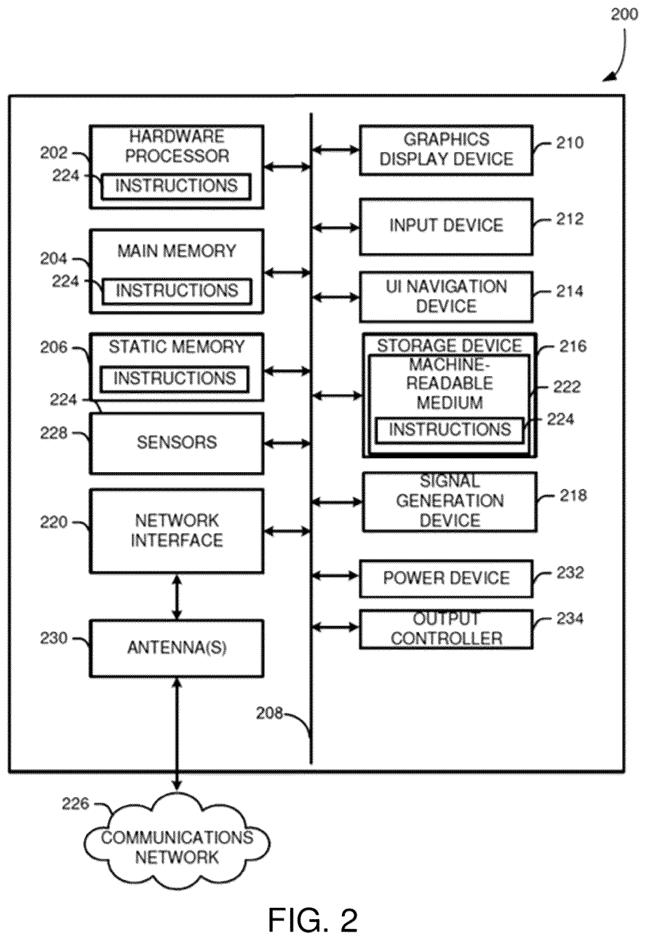

FIG. 2 illustrates a block diagram of an example of a machine 200 or system upon which any one or more of the techniques (e.g., methodologies) discussed herein may be performed. In other embodiments, the machine 200 may operate as a standalone device or may be connected (e.g., networked) to other machines. In a networked deployment, the machine 200 may operate in the capacity of a server machine, a client machine, or both in server-client network environments. The machine 200 may be a wearable device or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 200 may include any combination of the illustrated components. For example, the machine 200 may include a hardware processor 202 (e.g., a central processing unit (CPU), a graphics processing unit (GPU), a tensor processing unit (TPU) including an artificial intelligence application-specific integrated circuit (ASIC), a hardware processor core, or any combination thereof), a main memory 204 and a static memory 206, some or all of which may communicate with each other via an interlink (e.g., bus) 208. The machine 200 may further include a power management device 232, a graphics display device 210, an alphanumeric input device 212 (e.g., a keyboard), and a user interface (UI) navigation device 214 (e.g., a mouse). In an example, the graphics display device 210, alphanumeric input device 212, and UI navigation device 214 may be a touch screen display. The machine 200 may additionally include a storage device (i.e., drive unit) 216, a signal generation device 218 (e.g., a data signal), a network interface device/transceiver 220 coupled to antenna(s) 230, and one or more sensors 228, such as a sound detecting sensor (e.g., a microphone), accelerometers, magnetometers, location sensors, and the like. The machine 200 may include an output controller 234, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, other sensors, etc.)).

The storage device 216 may include a machine readable medium 222 on which is stored one or more sets of data structures or instructions 224 (e.g., software) embodying or utilized by any one or more of the techniques or functions described herein. The instructions 224 may also reside, completely or at least partially, within the main memory 204, within the static memory 206, or within the hardware processor 202 during execution thereof by the machine 200. In an example, one or any combination of the hardware processor 202, the main memory 204, the static memory 206, or the storage device 216 may constitute machine-readable media.

While the machine-readable medium 222 is illustrated as a single medium, the term “machine-readable medium” may include a single medium or multiple media (e.g., a centralized or distributed database, and/or associated caches and servers) configured to store the one or more instructions 224.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 200 and that cause the machine 200 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 224 may further be transmitted or received over a communications network 226 using a transmission medium via the network interface device/transceiver 220 utilizing any one of a number of transfer protocols (e.g., frame relay, internet protocol (IP), transmission control protocol (TCP), user datagram protocol (UDP), hypertext transfer protocol (HTTP), etc.). Example communications networks may include DOCSIS, fiber optic, a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.2 family of standards known as Wi-Fi®, IEEE 802.16 family of standards known as WiMax®), IEEE 802.15.4 family of standards, and peer-to-peer (P2P) networks, among others. In an example, the network interface device/transceiver 220 may include one or more physical jacks (e.g., Ethernet, coaxial, or phone jacks) or one or more antennas to connect to the communications network 226. In an example, the network interface device/transceiver 220 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 200 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cable box, a wearable smart device, cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Some embodiments may be used in conjunction with various devices and systems, for example, a wearable smart device, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, DOCSIS, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

All references, including publications, patent applications, and patents, cited are hereby incorporated by reference to the same extent as if each reference were individually and specifically indicated to be incorporated by reference and were set forth in its entirety.

FIG. 1 depicts multiple user interfaces, which may be used to access CLIMB. The multiple user interfaces may include PC, mobile, tablet, and others. In various embodiments, the multiple user interfaces refer to interfaces running on different types of computing devices that connect to CLIMB via a network. Instructions may be transmitted or received over a communications network using a transmission medium via the network interface device/transceiver utilizing any one of a number of transfer protocols (e.g., frame relay, internet protocol (IP), transmission control protocol (TCP), user datagram protocol (UDP), hypertext transfer protocol (HTTP), etc.). Example communications networks may include DOCSIS, fiber optic, a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.2 family of standards known as Wi-Fi®, IEEE 802.16 family of standards known as WiMax®), IEEE 802.15.4 family of standards, and peer-to-peer (P2P) networks, among others. In an example, the network interface device/transceiver may include one or more physical jacks (e.g., Ethernet, coaxial, or phone jacks) or one or more antennas to connect to the communications network. In an example, the network interface device/transceiver may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by a machine (e.g., as described in connection with FIG. 2) and includes digital or analog communications signals or other intangible media to facilitate communication of such software.

In various embodiments, a CLIMB server is access by servers to perform various actions. For example, a user may initially be prompted to perform a profile creation or to join the CLIMB network. This may involve using assessments, waivers, third-party authorization, etc. A user profile may be created or otherwise determined.

In various embodiments, a user is prompted to answer questions. This may be a required step that is performed as part of profile creation. In some cases, a user may be prompted to provide mandatory as well as optional information. Mandatory information may be required as part of profile creation (e.g., to establish and/or verify a user's identity), whereas optional information can be omitted by the user when creating his or her profile, and provided at a later point in time.

In various embodiments, a user is prompted to answer a set of questions. As noted, previously, there may be optional as well as mandatory questions. Mandatory questions may be required, for example, to verify the identity of the registrant, whereas optional questions may be information that can be provided at the user's discretion. Users may be incentivized to answer the optional questions to increase their CLIMB scores. Third-party ranking and/or third-party verification may be utilized. For example, third-party rankings may be furnished by nationally recognized system(s) that award the best institutions and third-party verification may be used to verify answers such as volunteer history. Volunteering in the community is a major factor captured in the model, and to ensure that the volunteering is being completed as disclosed by the users, third-party verification is used, as well as to receive on-going updates.

In various embodiments, a segment score is computed based on value compiled metrics that are generated, per segment. In various embodiments, the model generates a segment score by assigning all applicable questions a numerical value based upon the answer provided. Those answers are then captured and weighted with a proprietary calculation resulting in the individual scores for each of the segments covered. A second proprietary weighted calculation is then applied, blending the scores for each section, arriving at the CLIMB Score. The CLIMB Score is a numerical representation of the metrics, which serve as a foundation for the model.

FIG. 3 shows an illustrative example of a process 300 for implementing a blockchain-based risk assessment system, in accordance with one or more example embodiments of the present disclosure. In at least one embodiment, some or all of the process 300 (or any other processes described herein, or variations and/or combinations thereof) is performed under the control of one or more computer systems that store computer-executable instructions and may be implemented as code (e.g., computer-executable instructions, one or more computer programs, or one or more applications) executing collectively on one or more processors, by hardware, software, or combinations thereof. The code, in at least one embodiment, is stored on a computer-readable storage medium in the form of a computer program comprising a plurality of computer-readable instructions executable by one or more processors. The computer-readable storage medium, in at least one embodiment, is a non-transitory computer-readable medium. In at least one embodiment, at least some of the computer-readable instructions usable to perform the process 300 are not stored solely using transitory signals (e.g., a propagating transient electric or electromagnetic transmission). A non-transitory computer-readable medium does not necessarily include non-transitory data storage circuitry (e.g., buffers, caches, and queues) within transceivers of transitory signals. Process 300 may be implemented in the context of various systems and methods described elsewhere in this disclosure, such as those discussed in connection with FIGS. 1, 2, and 4. In at least one embodiment, process 300 or a portion thereof is implemented by a computing resource service provider such as a centralized server system (e.g., CLIMB server).

Process 300 may comprise a step 302 to provide one or more user interfaces, according to at least one embodiment of the present disclosure. This may be described in reference to (1) of FIG. 1. As depicted in FIG. 1, multiple user interfaces may be used to access CLIMB. The multiple user interfaces may include PC, mobile, tablet, and others. In various embodiments, the multiple user interfaces refer to interfaces running on different types of computing devices that connect to CLIMB via a network. Instructions may be transmitted or received over a communications network using a transmission medium via the network interface device/transceiver utilizing any one of a number of transfer protocols (e.g., frame relay, internet protocol (IP), transmission control protocol (TCP), user datagram protocol (UDP), hypertext transfer protocol (HTTP), etc.). Example communications networks may include DOCSIS, fiber optic, a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.2 family of standards known as Wi-Fi®, IEEE 802.16 family of standards known as WiMax®), IEEE 802.15.4 family of standards, and peer-to-peer (P2P) networks, among others. In an example, the network interface device/transceiver may include one or more physical jacks (e.g., Ethernet, coaxial, or phone jacks) or one or more antennas to connect to the communications network. In an example, the network interface device/transceiver may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by a machine (e.g., as described in connection with FIG. 2) and includes digital or analog communications signals or other intangible media to facilitate communication of such software.

Process 300 may comprise a step 304 to provide profile creation to users via the user interfaces, according to at least one embodiment of the present disclosure. This may be described in reference to (2) of FIG. 1. In various embodiments, a CLIMB server is access by servers to perform various actions. For example, a user may initially be prompted to perform a profile creation or to join the CLIMB network. This may involve using assessments, waivers, third-party authorization, etc. A user profile may be created or otherwise determined.

Process 300 may comprise a step 306 to prompt the user to answer a set of questions, according to at least one embodiment of the present disclosure. This may be described in reference to (3) of FIG. 1. In various embodiments, a user is prompted to answer questions. This may be a required step that is performed as part of profile creation. In some cases, a user may be prompted to provide mandatory as well as optional information. Mandatory information may be required as part of profile creation (e.g., to establish and/or verify a user's identity), whereas optional information can be omitted by the user when creating his or her profile, and provided at a later point in time.

In various embodiments, a user is prompted to answer a set of questions. As noted, previously, there may be optional as well as mandatory questions. Mandatory questions may be required, for example, to verify the identity of the registrant, whereas optional questions may be information that can be provided at the user's discretion. Users may be incentivized to answer the optional questions to increase their CLIMB scores. Third-party ranking and/or third-party verification may be utilized. For example, third-party rankings may be furnished by nationally recognized system(s) that award the best institutions and third-party verification may be used to verify answers such as volunteer history. Volunteering in the community is a major factor captured in the model, and to ensure that the volunteering is being completed as disclosed by the users, third-party verification is used, as well as to receive on-going updates.

Process 300 may comprise a step 308 to determine a segment score, according to at least one embodiment of the present disclosure. This may be described in reference to (4) of FIG. 1. In various embodiments, a segment score is computed based on value compiled metrics that are generated, per segment. In various embodiments, the model generates a segment score by assigning a numerical value based upon the answers provided. Those answers are then captured and weighted with a proprietary model that calculates the resulting in the individual scores for each of the segments covered. Process 300 may comprise a step 310 to determine a CLIMB score, according to at least one embodiment of the present disclosure. This may be described in reference to (5) of FIG. 1. A second proprietary weighted calculation is then applied, blending the scores for each section, arriving at the CLIMB score. The CLIMB score is a numerical representation of the metrics of Micro+Macro, which serve as a foundation for the model.

Process 300 may comprise a step 312 to provide a dashboard, according to at least one embodiment of the present disclosure. This may be described in reference to (6) of FIG. 1. In various embodiments, a dashboard is provided by the CLIMB servers to one or more user interfaces. The dashboard may also be referred to as a central hub. Users may use the dashboard to log updates to their questions and profiles, see their score, review comparative rankings, see suggestions, and coaching on how to improve their score, videos, testimonials, etc. The entire experience is built around the user with all interactions designed to encourage and prepare them for future challenges and growth.

Process 300 may comprise a step 314 to obtain third-party advertising, according to at least one embodiment of the present disclosure. This may be described in reference to (7) of FIG. 1. In various embodiments, third-party advertising is provided via the dashboards. In various embodiments, advertisers can serve digital content to various users of the CLIMB system based on the group's needs without sharing personal info. Individuals' information may be aggregated so that the identity of the specific individual is not ascertainable.

Process 300 may comprise a step 316 to provide help, contact, support, legal, or other services, according to at least one embodiment of the present disclosure. This may be described in reference to (8) of FIG. 1. In various embodiments, the CLIMB server is extensible and can provide external interfaces—for example, in the form of web service application programming interfaces (APIs) that represent access points for other companies or provides to plug into the CLIMB system. For example, external companies can tap into these access points to seek information on users for rental applications, loan applications, insurance verification, etc.

Process 300 may comprise a step 318 to store online documents and information, such as CLIMB score, according to at least one embodiment of the present disclosure. This may be described in reference to (9) of FIG. 1. In various embodiments, (9) of FIG. 1 refers to online document and information storage/retrieval to be used to house various types of data. For example, online document and information storage may be used to house financial, medical, and other personal data records for CLIMB users. distributed ledger may be used. As depicted in (10) of FIG. 1, a visual representation of security provided via a blockchain network. The blockchain network may be used to protect important documents and value exchange.

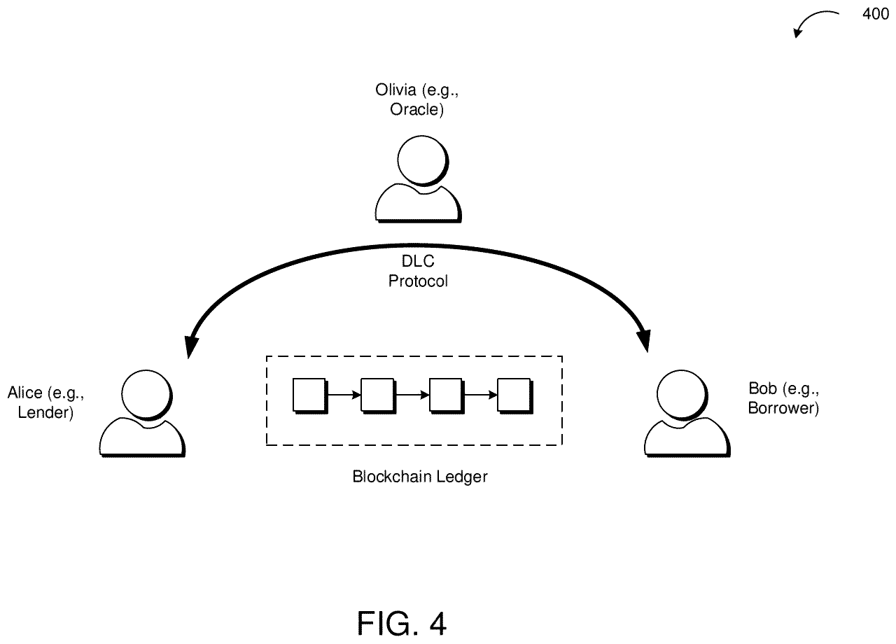

FIG. 4 depicts an illustrative computing environment 400 in which discreet log protocol (DLC) functionality may be implemented to facilitate blockchain-based risk assessment, according to at least one embodiment of the present disclosure.

Crosschain functionality, as described herein, may refer to processes, methods, and techniques to facilitate interoperability between distinct blockchain networks and to facilitate the exchange of assets, data, or information between them. Each blockchain operates as a self-contained network with its own rules and structure. However, there may, at time, be a need for one blockchain network to access data or information, or to execute functionality (e.g., in the form of smart contracts or decentralized apps) on a different blockchain network. Crosschain functionality may facilitate these activities by establishing protocols, technologies, or bridges that allow seamless interaction between different blockchains networks.

By enabling crosschain functionality, users and developers can access a broader range of assets and services, regardless of the blockchain they are primarily associated with. This can lead to improved scalability, enhanced liquidity, and increased flexibility within the blockchain ecosystem. Crosschain functionality also holds the potential to address various challenges, such as reducing transaction congestion on a single chain and fostering innovation by leveraging the strengths of multiple blockchain network. Further, there is a need to ensure security and maintain the integrity of transactions when implementing crosschain solutions, as they involve complex technical considerations to maintain consensus and prevent potential vulnerabilities.

In various embodiments, the crosschain functionality between various ecosystems outlined in this disclosure relate to Bitcoin, Ethereum, Web 2.0, etc. The protocol may be used by customers operating with bandwidth between the various ecosystems. In various embodiments, core concepts described in relation to crosschain functionality are described in relation to discrete log contracts, for example, those described in “Discreet Log Contracts” by Thaddeus Dryja of the MIT Digital Currency Initiative, the contents of which are hereby incorporated by reference.

As described herein, Discreet Log Contract (DLC) refers to a mechanism or system that provides for scalability of smart contracts while providing for privacy. A feature of DLC may be its reliance on an oracle to provide external data. DLC may employ various techniques to minimize the amount of trust required in the oracle. The contracts are discreet in that external observers cannot detect the presence of the contract in the transaction.

In various embodiments, the DLC protocol may be employed for a wide variety of smart contracts. A smart contract typically involves at least two counterparties, who may be referred to as Alice and Bob throughout this disclosure. More counterparties are possible—for example, a three-way contract may involve a third party, Charlie, and is contemplated within the scope of this disclosure. Continuing, an additional party to the smart contract involves an oracle. The oracle may be referred to as Olivia throughout this disclosure.

In further detail, a Discreet Log Contract may use the Schnoor signature. The Schnorr signature is a cryptographic digital signature scheme that offers strong security properties while being more efficient than traditional signature schemes like ECDSA (Elliptic Curve Digital Signature Algorithm). It enables the creation of compact and secure signatures that support various cryptographic operations, including multisignature transactions and interactive protocols, making it a versatile choice for blockchain and cryptocurrency applications. The Schnorr signature also has the advantage of allowing aggregation of multiple signatures into a single one, enhancing efficiency and privacy in multi-party transactions.

While Schnoor signatures are typically employed in blockchains to provide efficient and secure cryptographic verification of transactions and/or to enable multisignature wallets, in DLCs, these techniques are applied to the generation of a public key rather than a signature. Normally, users create a private scalar a, compute A=aG by repeated addition of the group generate G, and publish A as their public key. When signing a message, they create another random private scalar k, compute R=kG, and use R as part of the signature. However, in DLCs, the quantity R is instead re-classified as part of the public key rather than part of the signature.

By utilizing the DLC protocol, systems described herein (e.g., those discussed in connection with FIG. 1) are able to add value into a better, process-methodology to provide a better risk solution, not currently in the marketplace. The protocol is currently working in clarity language with developments into Rust. Both languages offer different use cases and operating properties native to ecosystem they are built for—such as community features and the option to better protect value/assets via self-custody. Because the protocol is open source, the technology will continue to evolve and develop into maturity by its developer community. While new as an industry—you can find current offerings of multisignature authorization transactions, realtime payment/settlement channels, on chain and off chain data transfer within smart contracts, the privacy controls place ownership back to the entities/parties involved in the transactions.

In various embodiments, techniques described herein for blockchain-based risk assessment systems may be implemented in accordance with one or more of the following clauses:

Clause 1. A computer-implemented method for implementing a blockchain-based risk assessment engine, comprising: providing, by one or more processors of a centralized server system, one or more user interfaces to a user; initiating, by the one or more processors of the centralized server system, a profile creation for the user; providing, by the one or more processors of the centralized server system, a set of questions to the user; receiving, by the one or more processors of the centralized server system, a corresponding set of answers to at least a portion of the set of questions; determining, by the one or more processors of the centralized server system and based at least in part on the corresponding set of answers, a plurality of segment scores associated with corresponding plurality of value metrics; determining, by the one or more processors of the centralized server system, a set of weights; computing, by the one or more processors of the centralized server system and based at least in part on the plurality of segment scores and the set of weights, a first blended score indicative of an overall risk assessment for the user; and broadcasting, by the one or more processors of the centralized server system, a smart contract to a public blockchain network, wherein the smart contract comprises executable code that, as a result of execution by one or more nodes of the public blockchain network, provides for an exchange of one or more digital assets with the user that is contingent upon evaluation of the first blended score, wherein permission to access the first blended score by the smart contract is controlled by a public key associated with the user.

Clause 2. The computer-implemented method of any preceding clause, wherein an Ethereum-based blockchain solution is used to implement the public blockchain network.

Clause 3. The computer-implemented method of any preceding clause, wherein the smart contract further comprises crosschain functionality to transfer the one or more digital assets between the public blockchain network and a second blockchain network.

Clause 4. The computer-implemented method of any preceding clause, wherein the plurality of segment scores comprises a segment score indicative of the user's potential earnings and repayment abilities.

Clause 5. The computer-implemented method of any preceding clause, further comprising: providing, by the one or more processors of the centralized server system, at least part of the corresponding set of answers to a third-party verification service.

Clause 6. The computer-implemented method of any preceding clause, further comprising: monitoring, by the one or more processors of the centralized server system, the public blockchain network to detect a block that updates one or more value metrics associated with the user; and computing, by the one or more processors of the centralized server system and based at least in part on the one or more value metrics, a second blended score for the user.

Clause 7. The computer-implemented method of any preceding clause, wherein the smart contract utilizes a Discreet Log Contract (DLC)-based protocol.

Clause 8. A computer system, comprising: one or more processors; and memory storing executable instructions that, as a result of execution by the one or more processors, cause the computer system to: provide one or more user interfaces to a user; initiate a profile creation for the user; provide a set of questions to the user; receive a corresponding set of answers to at least a portion of the set of questions; determine, based at least in part on the corresponding set of answers, a plurality of segment scores associated with corresponding plurality of value metrics; determine a set of weights; compute, based at least in part on the plurality of segment scores and the set of weights, a first blended score indicative of an overall risk assessment for the user; and broadcast a smart contract to a public blockchain network, wherein the smart contract comprises executable code that, as a result of execution by one or more nodes of the public blockchain network, provides for an exchange of one or more digital assets with the user that is contingent upon evaluation of the first blended score, wherein permission to access the first blended score by the smart contract is controlled by a public key associated with the user.

Clause 9. The computer system of any preceding clause, wherein an Ethereum-based blockchain solution is used to implement the public blockchain network.

Clause 10. The computer system of any preceding clause, wherein the smart contract further comprises crosschain functionality to transfer the one or more digital assets between the public blockchain network and a second blockchain network.

Clause 11. The computer system of any preceding clause, wherein the plurality of segment scores comprises a segment score indicative of the user's potential earnings and repayment abilities.

Clause 12. The computer system of any preceding clause, wherein the instructions, as a result of execution, further cause the computer system to: monitor the public blockchain network to detect a block that updates one or more value metrics associated with the user; and compute, based at least in part on the one or more value metrics, a second blended score for the user.

Clause 13. The computer system of any preceding clause, wherein the smart contract utilizes a Discreet Log Contract (DLC)-based protocol.

Clause 14. A non-transitory computer-readable storage medium storing executable instructions that, as a result of being executed by one or more processors of a computer system, cause the computer system to at least: provide one or more user interfaces to a user; initiate a profile creation for the user; provide a set of questions to the user; receive a corresponding set of answers to at least a portion of the set of questions; determine, based at least in part on the corresponding set of answers, a plurality of segment scores associated with corresponding plurality of value metrics; determine a set of weights; compute, based at least in part on the plurality of segment scores and the set of weights, a first blended score indicative of an overall risk assessment for the user; and broadcast a smart contract to a public blockchain network, wherein the smart contract comprises executable code that, as a result of execution by one or more nodes of the public blockchain network, provides for an exchange of one or more digital assets with the user that is contingent upon evaluation of the first blended score, wherein permission to access the first blended score by the smart contract is controlled by a public key associated with the user.

Clause 15. The non-transitory computer-readable storage medium of any preceding clause, wherein an Ethereum-based blockchain solution is used to implement the public blockchain network.

Clause 16. The non-transitory computer-readable storage medium of any preceding clause, wherein the smart contract further comprises crosschain functionality to transfer the one or more digital assets between the public blockchain network and a second blockchain network.

Clause 17. The non-transitory computer-readable storage medium of any preceding clause, wherein the plurality of segment scores comprises a segment score indicative of the user's potential earnings and repayment abilities.

Clause 18. The non-transitory computer-readable storage medium of any preceding clause, wherein the instructions, as a result of execution, further cause the computer system to: provide at least part of the corresponding set of answers to a third-party verification service.

Clause 19. The non-transitory computer-readable storage medium of any preceding clause 14, wherein the instructions, as a result of execution, further cause the computer system to: monitor the public blockchain network to detect a block that updates one or more value metrics associated with the user; and compute, based at least in part on the one or more value metrics, a second blended score for the user.

Clause 20. The non-transitory computer-readable storage medium of any preceding clause, wherein the smart contract utilizes a Discreet Log Contract (DLC)-based protocol.

What is claimed is:

1. A computer-implemented method for implementing a blockchain-based risk assessment engine, comprising:
providing, by one or more processors of a centralized server system, one or more user interfaces to a user;
initiating, by the one or more processors of the centralized server system, a profile creation for the user;
providing, by the one or more processors of the centralized server system, a set of questions to the user;
receiving, by the one or more processors of the centralized server system, a corresponding set of answers to at least a portion of the set of questions;
determining, by the one or more processors of the centralized server system and based at least in part on the corresponding set of answers, a plurality of segment scores associated with corresponding plurality of value metrics;
determining, by the one or more processors of the centralized server system, a set of weights;
computing, by the one or more processors of the centralized server system and based at least in part on the plurality of segment scores and the set of weights, a first blended score indicative of an overall risk assessment for the user; and
broadcasting, by the one or more processors of the centralized server system, a smart contract to a public blockchain network, wherein the smart contract comprises executable code that, as a result of execution by one or more nodes of the public blockchain network, provides for an exchange of one or more digital assets with the user that is contingent upon evaluation of the first blended score, wherein permission to access the first blended score by the smart contract is controlled by a public key associated with the user.

2. The computer-implemented method of claim 1, wherein an Ethereum-based blockchain solution is used to implement the public blockchain network.

3. The computer-implemented method of claim 1, wherein the smart contract further comprises crosschain functionality to transfer the one or more digital assets between the public blockchain network and a second blockchain network.

4. The computer-implemented method of claim 1, wherein the plurality of segment scores comprises a segment score indicative of the user's potential earnings and repayment abilities.

5. The computer-implemented method of claim 1, further comprising:
providing, by the one or more processors of the centralized server system, at least part of the corresponding set of answers to a third-party verification service.

6. The computer-implemented method of claim 1, further comprising:
monitoring, by the one or more processors of the centralized server system, the public blockchain network to detect a block that updates one or more value metrics associated with the user; and
computing, by the one or more processors of the centralized server system and based at least in part on the one or more value metrics, a second blended score for the user.

7. The computer-implemented method of claim 1, wherein the smart contract utilizes a Discreet Log Contract (DLC)-based protocol.

8. A computer system, comprising:
one or more processors; and
memory storing executable instructions that, as a result of execution by the one or more processors, cause the computer system to:
provide one or more user interfaces to a user;
initiate a profile creation for the user;
provide a set of questions to the user;
receive a corresponding set of answers to at least a portion of the set of questions;
determine, based at least in part on the corresponding set of answers, a plurality of segment scores associated with corresponding plurality of value metrics;
determine a set of weights;
compute, based at least in part on the plurality of segment scores and the set of weights, a first blended score indicative of an overall risk assessment for the user; and
broadcast a smart contract to a public blockchain network, wherein the smart contract comprises executable code that, as a result of execution by one or more nodes of the public blockchain network, provides for an exchange of one or more digital assets with the user that is contingent upon evaluation of the first blended score, wherein permission to access the first blended score by the smart contract is controlled by a public key associated with the user.

9. The computer system of claim 8, wherein an Ethereum-based blockchain solution is used to implement the public blockchain network.

10. The computer system of claim 8, wherein the smart contract further comprises crosschain functionality to transfer the one or more digital assets between the public blockchain network and a second blockchain network.

11. The computer system of claim 8, wherein the plurality of segment scores comprises a segment score indicative of the user's potential earnings and repayment abilities.

12. The computer system of claim 8, wherein the instructions, as a result of execution, further cause the computer system to:
monitor the public blockchain network to detect a block that updates one or more value metrics associated with the user; and
compute, based at least in part on the one or more value metrics, a second blended score for the user.

13. The computer system of claim 8, wherein the smart contract utilizes a Discreet Log Contract (DLC)-based protocol.

14. A non-transitory computer-readable storage medium storing executable instructions that, as a result of being executed by one or more processors of a computer system, cause the computer system to at least:
provide one or more user interfaces to a user;
initiate a profile creation for the user;
provide a set of questions to the user;
receive a corresponding set of answers to at least a portion of the set of questions;
determine, based at least in part on the corresponding set of answers, a plurality of segment scores associated with corresponding plurality of value metrics;
determine a set of weights;
compute, based at least in part on the plurality of segment scores and the set of weights, a first blended score indicative of an overall risk assessment for the user; and
broadcast a smart contract to a public blockchain network, wherein the smart contract comprises executable code that, as a result of execution by one or more nodes of the public blockchain network, provides for an exchange of one or more digital assets with the user that is contingent upon evaluation of the first blended score, wherein permission to access the first blended score by the smart contract is controlled by a public key associated with the user.

15. The non-transitory computer-readable storage medium of claim 14, wherein an Ethereum-based blockchain solution is used to implement the public blockchain network.

16. The non-transitory computer-readable storage medium of claim 14, wherein the smart contract further comprises crosschain functionality to transfer the one or more digital assets between the public blockchain network and a second blockchain network.

17. The non-transitory computer-readable storage medium of claim 14, wherein the plurality of segment scores comprises a segment score indicative of the user's potential earnings and repayment abilities.

18. The non-transitory computer-readable storage medium of claim 14, wherein the instructions, as a result of execution, further cause the computer system to:
provide at least part of the corresponding set of answers to a third-party verification service.

19. The non-transitory computer-readable storage medium of claim 14, wherein the instructions, as a result of execution, further cause the computer system to:
monitor the public blockchain network to detect a block that updates one or more value metrics associated with the user; and
compute, based at least in part on the one or more value metrics, a second blended score for the user.

20. The non-transitory computer-readable storage medium of claim 14, wherein the smart contract utilizes a Discreet Log Contract (DLC)-based protocol.
